(19) United States
(12) Patent Application Publication
(10) Pub. No.: US 2026/0050094 A1
(43) Pub. Date: Feb. 19, 2026

(54) X-RAY DETECTOR

(71) Applicants: RAYENCE Co., Ltd., Gyeonggi-do (KR); VATECH EWOO Holdings Co., Ltd., Gyeonggi-do (KR); Qpix solutions Inc., Morrisville, NC (US)

(72) Inventors: Jae Jeong SEO, Gyeonggi-do (KR); Kang Min HWANG, Gyeonggi-do (KR); Seungman YUN, Morrisville, NC (US)

(73) Assignees: RAYENCE Co., Ltd., Gyeonggi-do (KR); VATECH EWOO Holdings Co., Ltd., Gyeonggi-do (KR); Qpix solutions Inc., Morrisville, NC (US)

(21) Appl. No.: 19/296,866

(22) Filed: Aug. 11, 2025

Related U.S. Application Data
(60) Provisional application No. 63/683,406, filed on Aug. 15, 2024.

(51) Int. Cl. G01T 1/24

(52) U.S. Cl. CPC G01T 1/24

(57) ABSTRACT

Proposed is an X-ray detector. The X-ray detector includes a sensor panel which includes a sensor substrate and a photoconductor layer that is provided on the sensor substrate and which is formed such that at least a portion of the sensor panel has a curved shape, and includes a plate member which has a planar shape and which is attached to a rear surface of the sensor panel. Furthermore, the sensor panel is fixed to the plate member while the sensor panel maintains the curved shape.

### CROSS REFERENCE TO RELATED APPLICATION

This application claims the benefit of the filing date of U.S. Patent Provisional Application No. 63/683,406, filed Aug. 15, 2024, the teaches of which are incorporated herein their entirety by reference.

### BACKGROUND

### Technical Field

The present disclosure relates to an X-ray detector.

### Description of the Related Art

In recent years, a digital detector has become widely used for X-ray imaging.

X-ray detectors are divided into an indirect-conversion-type X-ray detector and a direct-conversion-type X-ray detector. In the indirect-conversion-type X-ray detector, X-rays are converted into visible light by using a scintillator, the visible light is converted into electrical signals, and then the electrical signals are detected. On the other hand, in the direct-conversion-type X-ray detector, a photoconductor configured to absorb X-rays and to directly generate electrical signals is used.

Recently, as a photoconductor, perovskite has attracted substantial attention. However, according to current research, perovskite as a there are limitations in applying photoconductor for X-ray detectors.

### SUMMARY

An objective of the present disclosure is to provide an X-ray detector in which perovskite is capable of being effectively used as a photoconductor of the X-ray detector.

In order to achieve the objective of the present disclosure, according to an aspect of the present disclosure, there is provided an X-ray detector including: a sensor panel including a sensor substrate and a photoconductor layer that is provided on the sensor substrate, the sensor panel being formed such that at least a portion of the sensor panel has a curved shape; and a plate member which has a planar shape and which is attached to a rear surface of the sensor panel, wherein the sensor panel is fixed to the plate member while the sensor panel maintains the curved shape.

The sensor panel may have the curved shape in which at least one corner of the sensor panel is positioned higher than other corners of the sensor panel.

The sensor panel may have the curved shape in which a diagonal corner of one side of the sensor panel is positioned higher than diagonal corners of other sides of the sensor panel.

The curved shape may be formed in a process of forming the photoconductor layer on the sensor substrate.

The photoconductor layer may include perovskite.

A thickness (t1) of the sensor substrate may be 10 um to 300 um.

A thickness (t2) of the photoconductor layer may be larger than the thickness (t1) of the sensor substrate within a range of 30 um to 3000 um.

A portion of a rear surface of the sensor substrate may be removed.

The sensor substrate may be a semiconductor substrate or an insulating substrate, and the plate member may be a circuit substrate or a metal plate.

According to the present disclosure, when the photoconductor layer formed of perovskite is formed, the sensor substrate having the thin thickness of 10 um to 300 um may be formed.

Accordingly, as the difference in thermal expansion coefficient between the photoconductor layer and the sensor substrate is reduced, stress applied to the photoconductor layer during the process of forming the photoconductor layer may be relieved. Therefore, damage to the photoconductor layer caused by the difference in thermal expansion coefficient between the photoconductor layer and the sensor substrate is reduced, so that defects such cracks on the photoconductor layer may be prevented from occurring.

### BRIEF DESCRIPTION OF THE DRAWINGS

FIG. 1 is a view schematically illustrating an X-ray detector according to an embodiment of the present disclosure;

FIG. 2 is a cross-sectional view schematically illustrating a sensor panel of the X-ray detector according to an embodiment of the present disclosure; and

FIG. 3 and FIG. 4 are a perspective view and a cross-sectional view that are respectively and schematically illustrating the X-ray detector in a state in which a plate member is attached to the sensor panel according to an embodiment of the present disclosure.

### DETAILED DESCRIPTION

Hereinafter, an embodiment of the present disclosure will be described in detail with reference to the drawings.

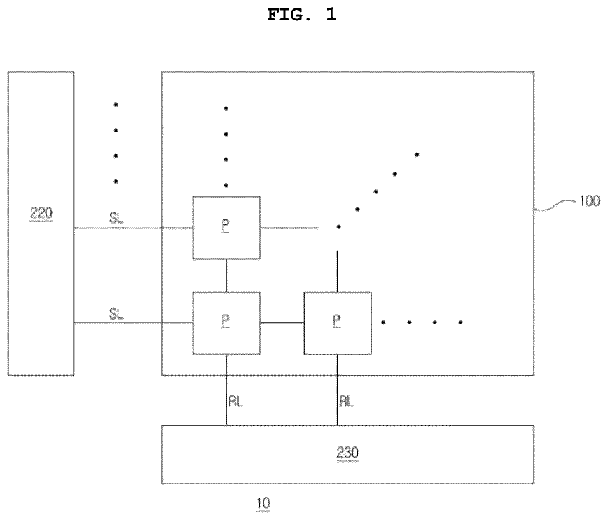

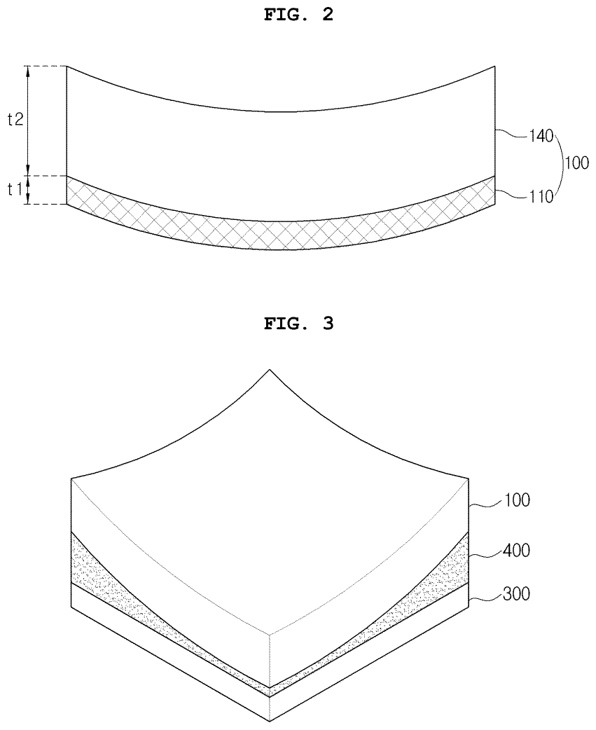

FIG. 1 is a view schematically illustrating an X-ray detector according to an embodiment of the present disclosure. FIG. 2 is a cross-sectional view schematically illustrating a sensor panel of the X-ray detector according to an embodiment of the present disclosure.

Referring to FIG. 1 and FIG. 2, an X-ray detector 10 according to an embodiment of the present disclosure corresponds to a direct-conversion-type X-ray detector provided with a photoconductor layer 140.

The X-ray detector 10 may include a sensor panel 100 and a driving circuit part that drives the sensor panel 100.

The sensor panel 100 may be a direct-conversion-type sensor panel 100 that directly converts incident X-rays into electrical signals.

Although not specifically illustrated, the sensor panel 100 may include an active region which is an area that actually receives and detects X-rays, and may include a non-active region positioned outside the active region.

In the active region, a pixel array formed of a plurality of pixels P is disposed on a sensor substrate 110, and the plurality of pixels P may be arranged in a matrix form along a plurality of row lines and a plurality of column lines.

In addition, a plurality of scan lines (or gate lines) SL extending along the plurality of row lines and a plurality of signal transmission lines (or data lines) RL extending along the plurality of column lines may be disposed on the sensor substrate 110. The scan lines SL and the signal transmission lines RL may be connected to corresponding pixels P.

Meanwhile, in the present embodiment, the sensor substrate 110 may be formed of a silicon wafer substrate (or a CMOS substrate) which is a semiconductor substrate, or may be formed of an insulating substrate such as a glass substrate or a synthetic resin substrate, but is not limited thereto.

The driving circuit part that drives the sensor panel 100 may include a scan circuit 220 and a readout circuit 230.

Here, the scan circuit 220 is configured to sequentially scan the scan lines SL and to apply a scan signal of a turn-on level. Accordingly, individual row line is sequentially selected, and data which is an electrical signal stored in the pixel P positioned in the selected row line may be output to the corresponding signal transmission line RL. Then, the readout circuit 230 may receive the data stored in the pixel P through the signal transmission line RL.

Each pixel P of the sensor panel 100 may be provided with a photoconductive element configured to detect X-rays and to generate a corresponding electrical signal.

In this regard, referring to FIG. 2, the photoconductive element may include the photoconductor layer 140 formed on the sensor substrate 110. Meanwhile, although not specifically illustrated, the photoconductive element may include a first electrode (or a pixel electrode) that is a lower electrode positioned below the photoconductor layer 140, and may include a second electrode (or a common electrode) that is an upper electrode positioned on the photoconductor layer 140.

For example, the photoconductor layer 140 constituting the photoconductive element may be continuously formed along the plurality of pixels P substantially disposed in the active region. In other words, the photoconductor layer 140 may be formed corresponding to the plurality of pixels P disposed in the active region.

As a photoconductor forming the photoconductor layer 140, perovskite may be used.

In this regard, perovskite corresponds to a material having a crystal structure of ABX3. Here, A denotes a monovalent cation, B denotes a metal cation, and X may denote a halide anion.

For example, such perovskite may be CsPbBr3, Cs2AgBiBr6, MAPbI3, or MAPbBr3, but is not limited thereto.

In addition, the photoconductor layer 140 may be formed by a solution method. As an example of the solution method, the photoconductor layer 140 may be formed through a process of applying and curing a solution (or a paste) containing a perovskite powder and a solvent onto the sensor substrate 110.

Meanwhile, the photoconductor layer 140 formed of perovskite has a difference in thermal expansion coefficient compared to the sensor substrate 110. Due to such a difference in thermal expansion coefficient, the photoconductor layer 140 may be damaged during a process of forming the photoconductor layer 140. Specifically, during a curing process, the photoconductor layer 140 may be damaged, which may cause defects such as cracks in the photoconductor layer 140.

In order to prevent such damage to the photoconductor layer 140, the difference in thermal expansion coefficient may be reduced by adjusting a thickness t2 (a second thickness) of the photoconductor layer 140 and a thickness t1 (a first thickness) of the sensor substrate 110, thereby being capable of reducing a stress applied to the photoconductor layer 140.

In this regard, the first thickness t1, which is the thickness t1 of the sensor substrate 110, may be configured to be smaller than the conventional designs. For example, the first thickness t1 may preferably be 10 um to 500 um, and more preferably be 30 um to 300 um.

In addition, the photoconductor layer 140 of perovskite may be formed thicker than the sensor substrate 110. For example, the second thickness t2, which is the thickness t2 of the photoconductor layer 140, may preferably be 30 um to 3000 μm, and may more preferably be 30 um to 600 um.

As such, in the present embodiment, the first thickness t1 of the sensor substrate 110 may be set relatively thin, and the second thickness t2 of the photoconductor layer 140 may be set relatively thick.

In other words, the photoconductor layer 140 and the sensor substrate 110 may be formed such that the thicker the second thickness t2 of the photoconductor layer 140 is, the thinner the first thickness t1 of the sensor substrate 110 is. That is, the first thickness t1 of the sensor substrate 110 and the second thickness t2 of the photoconductor layer 140 may be set in an inversely proportional relationship to each other.

As such, since the thickness of the sensor substrate 110 is set to be thinner compared to the thickness of the photoconductor layer 140, the difference in thermal expansion coefficient between the photoconductor layer 140 and the sensor substrate 110 may be reduced. That is, even when the shape of the photoconductor layer 140 is deformed during the process of forming the photoconductor layer 140, especially during the curing process, the sensor substrate 110 is also deformed together with the photoconductor layer 140, so that damage to the photoconductor layer 140 is reduced, thereby being capable of preventing the occurrence of defects such as cracks on the photoconductor layer 140.

Meanwhile, in relation to the implementation of the first thickness t1 of the sensor substrate 110 as described above, when the sensor substrate 110 is a silicon wafer substrate or a glass substrate, a so-called thinning process in which a portion of the sensor substrate 110 is removed in a thickness direction from a rear surface of the sensor substrate 110 may be performed, thereby forming the thickness of the sensor substrate 110 to have the first thickness t1.

In addition, when the sensor substrate 110 is a flexible substrate such as a plastic substrate, the sensor substrate 110 having the first thickness t1 may be formed and then the photoconductor layer 140 may be formed.

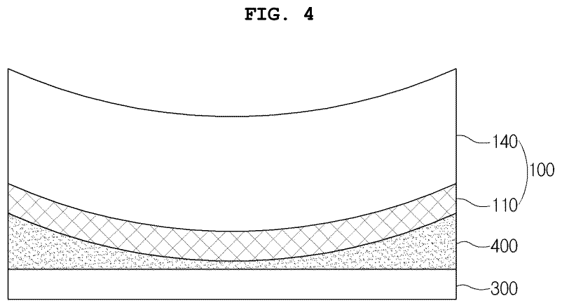

Meanwhile, in the present embodiment, a separate plate member for stress reduction may be attached to the rear surface of the sensor substrate 110, which will be described with reference to FIG. 3 and FIG. 4. FIG. 3 and FIG. 4 are a perspective view and a cross-sectional view that are respectively and schematically illustrating the X-ray detector in a state in which a plate member is attached to the sensor panel according to an embodiment of the present disclosure.

Referring to FIG. 3, a plate member 300 may be attached to the rear surface of the sensor substrate 110 of the sensor panel 100.

For example, such a plate member 300 may be attached to and coupled to the rear surface of the sensor substrate 110 through an adhesive 400. Such a plate member 300 may be configured to substantially cover the entire rear side of the sensor substrate 110 corresponding to the entire rear surface of the sensor substrate 110, but is not limited thereto and the plate member 300 may be configured to correspond to a portion of the sensor substrate 110.

Such a plate member 300 may serve to maintain the shape of the sensor panel 100. For example, when the sensor panel 100 is not flat and is bent, the plate member 300 may be attached to the sensor panel 100 while the sensor panel 100 is bent, so that a bent state of the sensor panel 100 may be maintained while the plate member 300 is coupled to the sensor panel 100. In other words, the plate member 300 may be configured to maintain the shape of the sensor panel 100 without deforming the shape of the sensor panel 100 before the plate member 300 is attached to the sensor panel 100.

That is, the plate member 300 maintains a planar shape, and the sensor panel 100 includes a curved shape, but the adhesive 400 is filled between the plate member 300 and the sensor panel 100, so that the shape of the sensor panel 100 may be maintained. Particularly, the sensor panel 100 may be in a state in which at least one corner of the sensor panel 100 is curved relatively higher than another corner. For example, the sensor panel 100 may be in a state in which a pair of diagonal corners of the sensor panel 100 is curved higher than a pair of diagonal corners of another pair of diagonal corners. Furthermore, while the sensor panel 100 maintains the curved shape, the adhesive 400 is filled between the sensor panel 100 and the plate member 300 so that the adhesive 400 fills a space between the sensor panel 100 and the plate member 300 and fix the sensor panel 100 and the plate member 300, so that the bent shape of the sensor panel 100 with respect to the plate member 300 having the planar shape may be maintained.

As a plate phase member 300, a circuit board having a driving circuit part that drives the sensor panel 100 or a separate supporting plate formed of metal may be used.

In this regard, for example, when the sensor substrate 110 of the sensor panel 100 is a silicon wafer substrate, the circuit board may be used as a plate member 300. Such a circuit board may be connected to a pad electrode of the sensor substrate 110 through a wire bonding.

In addition, when the sensor substrate 110 of the sensor panel 100 is a so-called TFT substrate formed of a glass substrate or a plastic substrate, the plate member 300 may be a separate supporting plate formed of metal. Here, the metal may be, for example, Al or Mg for X-ray and electromagnetic shielding, but is not limited thereto.

As described above, in the present embodiment, the plate member 300 may be used for maintaining the shape of the sensor panel 100 before the circuit substrate or the supporting plate is attached.

Meanwhile, the adhesive 400 that attaches the plate member 300 to the sensor panel 100 may be formed of, for example, a thermosetting resin, and epoxy and so on may be used as a thermosetting resin, but is not limited thereto.

As described above, in an embodiment of the present disclosure, when the photoconductor layer 140 formed by using perovskite is formed, the sensor substrate 110 may have a thin thickness such that the thickness of the sensor substrate 110 has an inverse relationship with the thickness of the photoconductor layer 140.

Accordingly, since the difference in thermal expansion coefficient between the photoconductor layer 140 and the sensor substrate 110 may be reduced, stress due to the difference in thermal expansion coefficient may be reduced in the manufacturing process of the sensor panel 100 after the photoconductor layer 140 is formed. Therefore, damage to the photoconductor layer 140 due to the difference in thermal expansion coefficient is reduced, so that defects such as cracks on the photoconductor layer 140 may be prevented from occurring.

The above-described embodiment of the present disclosure is an example of the present disclosure, and free modification is possible within the scope included in the spirit of the present disclosure. Accordingly, the present disclosure includes modifications of the present disclosure within the scope of the appended claims and the equivalents thereof.

What is claimed is:

1. An X-ray detector comprising:
a sensor panel comprising a sensor substrate and a photoconductor layer that is provided on the sensor substrate, the sensor panel being formed such that at least a portion of the sensor panel has a curved shape; and
a plate member which has a planar shape and which is attached to a rear surface of the sensor panel,
wherein the sensor panel is fixed to the plate member while the sensor panel maintains the curved shape.

2. The X-ray detector of claim 1, wherein the sensor panel has the curved shape in which at least one corner of the sensor panel is positioned higher than other corners of the sensor panel.

3. The X-ray detector of claim 1, wherein the sensor panel has the curved shape in which a diagonal corner of one side of the sensor panel is positioned higher than diagonal corners of other sides of the sensor panel.

4. The X-ray detector of claim 1, wherein the curved shape is formed in a process of forming the photoconductor layer on the sensor substrate.

5. The X-ray detector of claim 1, wherein the photoconductor layer comprises perovskite.

6. The X-ray detector of claim 1, wherein a thickness (t1) of the sensor substrate is 10 um to 300 um.

7. The X-ray detector of claim 6, wherein a thickness (t2) of the photoconductor layer is larger than the thickness (t1) of the sensor substrate within a range of 30 um to 3000 um.

8. The X-ray detector of claim 6, wherein a portion of a rear surface of the sensor substrate is removed.

9. The X-ray detector of claim 1, wherein the sensor substrate is a semiconductor substrate or an insulating substrate, and the plate member is a circuit substrate or a metal plate.
